(19) United States
(12) Patent Application Publication
(10) Pub. No.: US 2022/0062941 A1
(43) Pub. Date: Mar. 3, 2022

(54) KEEN SPRINKLER BASE

(71) Applicant: Devin Keen, Floresville, TX (US)

(72) Inventor: Devin Keen, Floresville, TX (US)

(21) Appl. No.: 17/003,970

(22) Filed: Aug. 26, 2020

(51) Int. Cl. B05B 15/622; B05B 15/628

(52) U.S. Cl. CPC B05B 15/622; B05B 15/628

(57) ABSTRACT

An article of manufacture for an adjustable sprinkler base for use with a spike-type sprinkler is disclosed. The article includes a flat sprinkler base member having a top surface and a bottom surface, a plurality of adjustable legs coupled to the bottom surface of the flat sprinkler base member, and a spike insertion hole through the flat sprinkler base member between the top surface and the bottom surface, the spike insertion hole configured to accept a spike sprinkler in place while in user.

### TECHNICAL FIELD

This application relates in general to an article of manufacture for providing a yard-watering device, and more specifically, to an article of manufacture for an adjustable sprinkler base for use with a spike-type sprinkler.

### BACKGROUND

Yard sprinklers are useful to homeowners to keep the lawns and plants healthy. Routine use of ordinary sprinklers may result in the failure of these devices from the wear of moving parts and issues caused by deposits from hard water. Expensive sprinklers that make watering an area simple are typically the most expensive types of available devices. The ease of use is in part because of the ability of users to direct the water spray into patterns that cover desired areas of the property. Simpler and less expensive sprinklers to not provide a similar amount of control over the pattern of the water spray.

Therefore, a need exists for an article of manufacture for providing an adjustable sprinkler base for use with a spike-type sprinkler. Such a device may permit users to utilize the less expensive sprinkler devices while obtaining most of the needed ability to control the pattern of generated water spray. The present invention attempts to address some of the limitations and deficiencies found in existing solutions using the principles and embodiments disclosed herein.

### SUMMARY

In accordance with the present invention, the above and other problems are solved by providing an article of manufacture for an adjustable sprinkler base for use with a spike-type sprinkler according to the principles and example embodiments disclosed herein.

In one embodiment, the present invention is an article of manufacture for providing an adjustable sprinkler base for use with a spike-type sprinkler. The article a flat sprinkler base member having a top surface and a bottom surface, a plurality of adjustable legs coupled to the bottom surface of the flat sprinkler base member, and a spike insertion hole through the flat sprinkler base member between the top surface and the bottom surface, the spike insertion hole configured to accept a spike sprinkler in place while in user.

In another aspect of the present invention, the plurality of adjustable legs are individually adjustable in length.

In yet another aspect of the present invention, the plurality of adjustable legs each have a telescoping leg member.

In yet another aspect of the present invention, the plurality of adjustable legs are adjustable about each leg coupling to the bottom surface of the flat sprinkler base member

In yet another aspect of the present invention, the plurality of adjustable legs each have a thru hole for providing an attachment of ground insertable spikes to hold the sprinkler base in place while in use.

In yet another aspect of the present invention, the spike insertion hole is shaped as a star to match a shape of the spike sprinkler

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate example prior art embodiments for yard sprinklers.

FIG. 2 illustrates an example embodiment of an article of manufacture for an adjustable sprinkler base for use with a spike-type sprinkler according to the present invention.

FIGS. 3a-b illustrate a top and a side view of an example embodiment of an article of manufacture for an adjustable sprinkler base for use with a spike-type sprinkler according to the present invention.

### DETAILED DESCRIPTION

This application relates in general to an article of manufacture for providing a yard-watering device, and more specifically, to an article of manufacture for an adjustable sprinkler base for use with a spike-type sprinkler according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “customer,” and “user” refer to an entity, e.g. a human, using the adjustable sprinkler base for use with a spike-type sprinkler associated with the invention. The term user herein refers to one or more users.

The term “invention” or “present invention” refers to the invention being applied for via the patent application with the title “Keen Sprinkler Base.” Invention may be used interchangeably with sprinkler base.

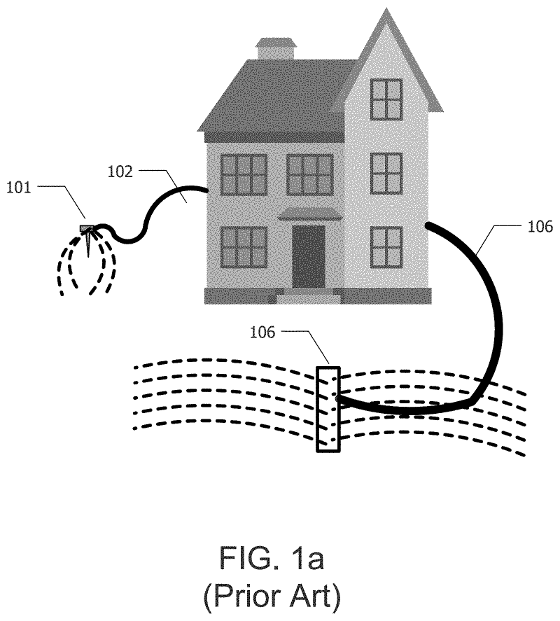

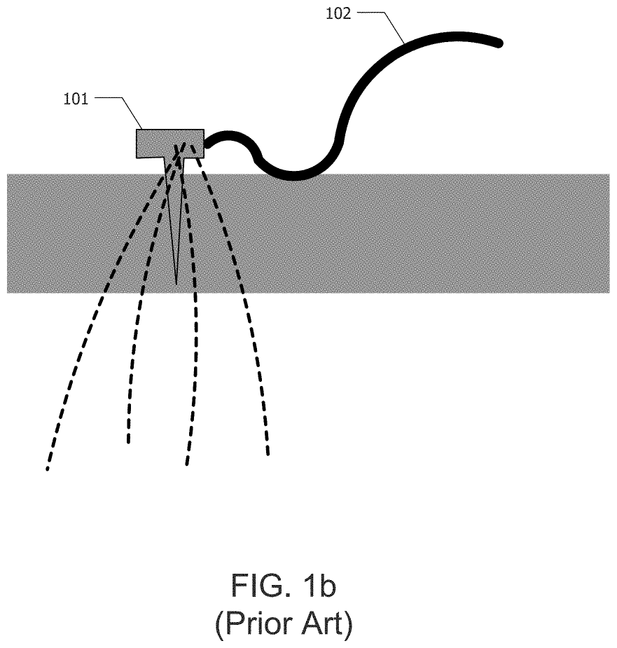

In general, the present disclosure relates to an article of manufacture for providing a yard-watering device. To better understand the present invention, FIGS. 1a-b illustrate example prior art embodiments for yard sprinklers. Prior art sprinkler solutions typically involve connecting a sprinkler 101, 105 to a source of water using a hose 102, 106. The sprinklers 101, 105 may be of several types; the simplest is a spike sprinkler 101 that is a common directional sprinkler that is stuck into the ground at a location that is to be watered and spray from a sprinkler head is disbursed about the yard. The spike sprinkler 101 typically is one of the easiest sprinklers to use and is also one of the most inexpensive devices available. Spike sprinklers 101 do, however, require user intervention throughout a watering cycle to change the orientation of the sprinkler head to ensure coverage over an entire area of interest.

An oscillating sprinkler 105 is also shown hooked to a water source using a hose 106. The oscillating sprinkler 105 includes a moving sprinkler head that moves between two positional settings as the water flows out of the sprinkler head. This type of sprinkler typically may provide coverage over a larger area without intervention from a user. Because this type of sprinkler has moving parts and possibly changeable settings that control the spray pattern when used, these sprinklers 105 typically are more expensive than spike sprinklers and are more prone to mechanical failure over time.

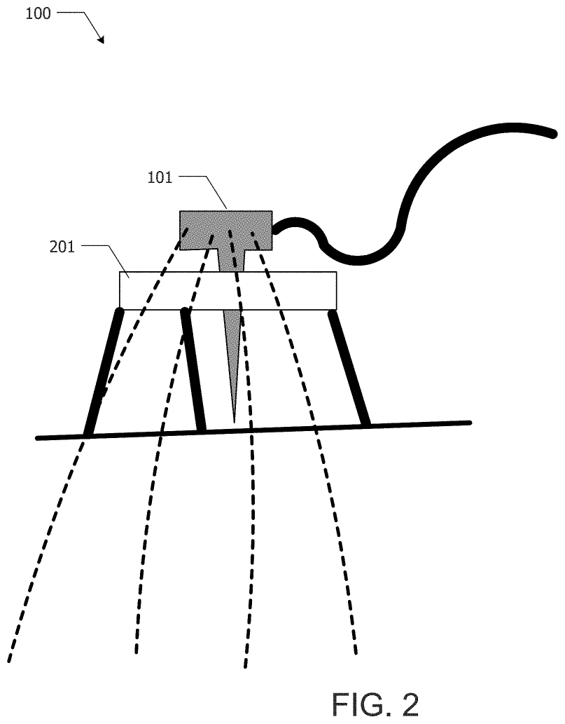

FIG. 2 illustrates an example embodiment of an article of manufacture for an adjustable sprinkler base for use with a spike-type sprinkler according to the present invention. FIG. 2 shows a spike end 103 of the sprinkler 101 inserted into the ground and the hose 102 connected to a water source. The spray of water is directed out of the sprinkler head 104 to cover an area to be watered.

The example shown in FIG. 2 shows the sprinkler head directing the water spray in one direction only. Using this type of spike sprinkler 101, the user is required to repeatedly reposition the sprinkler head 104 into different directions to provide coverage across a larger area. Other variants of the sprinkler head 104 are possible that may direct the water spray in more than one direction at a time while still using a fixed non-moving head unit that may fail and is more expensive to replace.

A flat sprinkler base member 201 of the present invention provides an adjustable base into which an ordinary spike sprinkler 101 may be inserted into a spike insertion hole 202 to position the sprinkler 101 into a desired orientation. The flat sprinkler base member 201 has a plurality of adjustable legs 202a-c that support the base 201 and permit the flat sprinkler base member, and thus the sprinkler head 104, to be positioned easily into a variety of different orientations to provide the water spray coverage over a particular area of the yard. The flat sprinkler base member 201 also includes the spike insertion hole 202 through the flat sprinkler base member 201 that may be shaped to accept a spike sprinkler 101 and hold it in place.

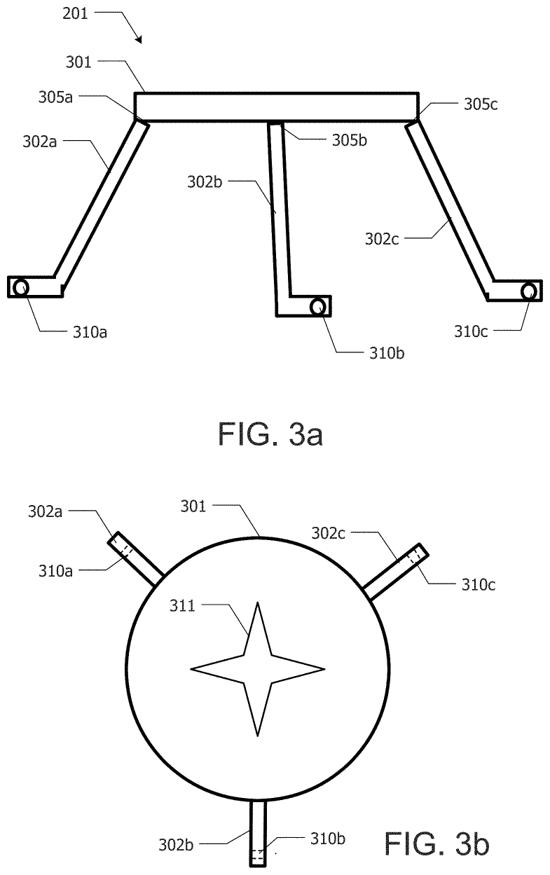

FIGS. 3a-b illustrate a top and a side view of an example embodiment of an article of manufacture for an adjustable sprinkler base for use with a spike-type sprinkler according to the present invention. FIG. 3a shows a side view of the flat sprinkler base member 301 along with a set of adjustable legs 302a-c. In this embodiment, the flat sprinkler base member 301 has a set of 3 adjustable legs 302a-c spaced equally about the flat sprinkler base member 301. Of course, one skilled in the art will recognize other numbers of adjustable legs may be used along with different shapes for the base 301.

The adjustable legs 302a-c are coupled to the flat sprinkler base member 301 using connection devices such as hinges, adjustable ball and sockets, rotating attachments, and other mechanisms that permit the orientation of the adjustable legs to be varied as needed by the user to position the sprinkler head 104 into a desired direction. Fixed attachment mechanisms including table leg screw and socket sets, screws into both the legs 302a-c and the base 301, and similar mechanisms also may be used while limiting the possible orientations for the spike sprinkler 101 used with the flat sprinkler base member 301.

In the example embodiment of FIG. 3a, the adjustable legs 302a-c also are shown as having a fixed length. One skilled in the art will recognize that the adjustable legs 302a-c may also be varied in length using extendable or telescoping mechanisms that shorten and lengthen the legs 302a-c as desired. Use of different length leg settings results in the base 301 being oriented into a non-level arrangement that may assist the user in obtaining an orientation and water spray pattern that provides desired coverage.

Lastly, the adjustable legs 302a-c, may include a through hole 310a-c within in each of the adjustable legs to provide an attachment of ground insertable spikes or stakes to hold the sprinkler base 301 in place while in use.

FIG. 3b shows a top down view of the sprinkler base 301 along with the set of adjustable legs 302a-c. A spike insertion star 311 is located in the center of the base 301 that accepts the spike end 103 to position the sprinkler head 104 above the base. The spike insertion star 311 is shaped to match a typical shape of the spike end 103 of the spike sprinkler 101. Other shapes for the insertion of the sprinkler 101 into the base 301 can match the type of sprinkler to be used. Additionally, the base 301 may include multiple insertion stars 311 in various orientations that may permit more than one spike sprinkler 101 to be used at a time.

The sprinkler base 301 may be constructed using different types of material including wood, plastic, aluminum, steel, and other metals depending upon the durability and cost of the device to be desired.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing an adjustable sprinkler base for use with a spike-type sprinkler, the article comprises:
a flat sprinkler base member having a top surface and a bottom surface;
a plurality of adjustable legs coupled to the bottom surface of the flat sprinkler base member; and
a spike insertion hole through the flat sprinkler base member between the top surface and the bottom surface, the spike insertion hole configured to accept a spike sprinkler in place while in user.

2. The article of manufacture according to claim 1, wherein the plurality of adjustable legs are individually adjustable in length.

3. The article of manufacture according to claim 2, wherein the plurality of adjustable legs each have a telescoping leg member.

4. The article of manufacture according to claim 1, wherein the plurality of adjustable legs are adjustable about each leg coupling to the bottom surface of the flat sprinkler base member.

5. The article of manufacture according to claim 1, wherein the plurality of adjustable legs each have a thru hole for providing an attachment of ground insertable spikes to hold the sprinkler base in place while in use.

6. The article of manufacture according to claim 1, wherein the spike insertion hole is shaped as a star to match a shape of the spike sprinkler.
